(19) United States
(12) Patent Application Publication
(10) Pub. No.: US 2025/0071617 A1
(43) Pub. Date: Feb. 27, 2025

(54) DYNAMIC STEERING OF MVNO'S UE SUBSCRIPTIONS TO OPERATOR NETWORKS WITH 5GAAS

(71) Applicant: Cisco Technology, Inc., San Jose, CA (US)

(72) Inventors: Vimal Srivastava, Bangalore (IN); Sri Gundavelli, San Jose, CA (US)

(21) Appl. No.: 18/453,590

(22) Filed: Aug. 22, 2023

(51) Int. Cl. H04W 28/084; H04W 28/08; H04W 72/56

(52) U.S. Cl. CPC H04W 28/084; H04W 28/0925; H04W 72/56

(57) ABSTRACT

Methods, systems, and non-transitory computer-readable media for dynamic control of the distribution of user equipment (UE's) over multiple Radio Access Network (RAN) partners include receiving analytics at a customer application function from a mobile virtual network operator (MVNO) application function, the analytics based on monitoring a dynamic traffic status of one or more nodes servicing a subscriber device, receiving negotiated service rate plans from a plurality of mobile network operator (MNO) networks, and determining one or more policies managing a traffic distribution of subscriber devices within the plurality of MNO networks. The method also includes dynamically switching telecommunications traffic by sending instructions to the subscriber device to modify a prioritized list of the plurality of MNO networks in accordance with the one or more policies.

### BACKGROUND

A radio access network (RAN) is the part of a mobile network that connects end-user devices, like smartphones, to the cloud. This is achieved by sending information via radio waves from end-user devices to a RAN's transceivers, and finally from the transceivers to the core network which connects to the global internet. For telecommunications network operators, RANs are crucial connection points that represent significant overall network expenses, perform intensive and complex processing, and now face rapidly increasing demand as more edge and 4G/5G use cases emerge for telecommunications customers.

RANs have evolved from the first generation (1G) to the fifth generation (5G) of cellular networking. With the development of fourth generation (4G) technology, the 3rd Generation Partnership Project introduced Long-Term Evolution (LTE) RAN, and the radio access network and the core network changed significantly. With 4G, system connectivity for the first time was based on the Internet Protocol (IP), replacing the previous circuit-based networks. Now, with LTE Advanced and 5G, improvements are coming in the form of centralized RAN, also called cloud RAN (C-RAN), and multiple antenna arrays, such as multiple input, multiple output (MIMO).

Since the first cellular networks were introduced, the capabilities of RAN have expanded to include voice calls, text messaging, and video and audio streaming. The types of user equipment using these networks have drastically increased, including all types of vehicles, drones, and internet of things devices. A mobile network operator (MNO), also known as a wireless service provider, wireless carrier, cellular company, or mobile network carrier, is a provider of wireless communications services that owns or controls all the elements necessary to sell and deliver services to an end user, including radio spectrum allocation, wireless network infrastructure, back haul infrastructure, billing, customer care, provisioning computer systems, and marketing and repair organizations

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example 5G as a Service (5GaaS) computing architecture in accordance with an example embodiment.

FIG. 2 illustrates a flowchart for dynamically controlling the distribution of user equipment (UEs) over different Radio Access Network (RAN) partners in accordance with an example embodiment.

FIG. 3A illustrates an example communication diagram for implementing a dynamically controlled distribution of UEs over multiple RAN partners in accordance with an example embodiment.

FIG. 3B further illustrates an example communication diagram for implementing a dynamically controlled distribution of UEs over multiple RAN partners in accordance with an example embodiment.

FIG. 3C further illustrates an example communication diagram for implementing a dynamically controlled distribution of UEs over multiple RAN partners in accordance with an example embodiment.

FIG. 3D further illustrates an example communication diagram for implementing a dynamically controlled distribution of UEs over multiple RAN partners in accordance with an example embodiment.

FIG. 4 shows an example of a computing system, according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

The present disclosure is directed to dynamically controlling the distribution of user equipment (UEs) over different Radio Access Network (RAN) partners. The systems and methods describe moving sessions from one mobile network operator (MNO) to other MNOs by triggering Steering of Roaming (SoR) from one or more mobile virtual network operators (MVNOs) based on policies received from a customer application function (AF). The MVNO determines the UEs whose sessions are to be moved based on the policies and sends the SoR with an updated RPL (roaming partner's list). Additionally, the MVNO will provide usage analytics to the customer AF so that these analytics can be used in generating traffic movement policies.

In one aspect, a method includes receiving analytics at a customer application function from a mobile virtual network operator (MVNO) application function, the analytics based on monitoring a dynamic traffic status of one or more nodes servicing a subscriber device, receiving negotiated service rate plans from a plurality of mobile network operator (MNO) networks, and determining one or more policies managing a traffic distribution of subscriber devices within the plurality of MNO networks. The method also includes dynamically switching telecommunications traffic by sending instructions to the subscriber device to modify a prioritized list of the plurality of MNO networks in accordance with the one or more policies.

In another aspect, the method further includes determining to move a subset of the subscriber devices within a location from a first MNO network to a second MNO network based on receiving the analytics and the negotiated service rate plans, identifying all subscriber devices within the subset of the subscriber devices that belong to the location, and sending a steering of roaming (SoR) request to all the subscriber devices to modify the prioritized list of the plurality of MNO networks to prioritize the first MNO network over the second MNO network. Other technical features may be readily apparent to one skilled in the art from the following figures, descriptions, and claims.

In another aspect, the method further includes determining a roaming partner's list (RPL) for the subscriber device based on a current load of the one or more nodes and a configured load, modifying a steering of roaming (SoR) request for the subscriber device, and sending the SoR request to a Unified Data Management (UDM) service to trigger SoR towards the subscriber device. Other technical features may be readily apparent to one skilled in the art from the following figures, descriptions, and claims.

In another aspect, the one or more policies include an operator specific policy of a second MNO network that is applied to the subscriber device when the subscriber device is dynamically moved from a first MNO network to the second MNO network. Other technical features may be readily apparent to one skilled in the art from the following figures, descriptions, and claims.

In another aspect, the analytics provides to the customer application function, for each MNO network, one or more of a volume of traffic specific to Data Network Name (DNN) slices to divide a physical network infrastructure associated with each MNO network into multiple virtual networks, each with its own resources and quality of service (QoS) requirements. Other technical features may be readily apparent to one skilled in the art from the following figures, descriptions, and claims.

In another aspect, the one or more policies are based on running a cost analysis for its subscriber devices across each MNO network. Other technical features may be readily apparent to one skilled in the art from the following figures, descriptions, and claims.

In another aspect, the one or more policies managing the traffic distribution move connections from the subscriber device from a first MNO network to a second MNO network based on a DNN slice of the subscriber device. Other technical features may be readily apparent to one skilled in the art from the following figures, descriptions, and claims.

In another aspect, the one or more policies managing the traffic distribution move connections from the subscriber device from a first MNO network to a second MNO network based on a 5G globally unique Subscription Permanent Identifier (SUPI) range of the subscriber device. Other technical features may be readily apparent to one skilled in the art from the following figures, descriptions, and claims.

In one aspect, a computing apparatus includes a processor and a memory storing instructions that, when executed by the processor, configure the apparatus to receive analytics at a customer application function from a mobile virtual network operator (MVNO) application function, the analytics based on monitoring a dynamic traffic status of one or more nodes servicing a subscriber device, receive negotiated service rate plans from a plurality of mobile network operator (MNO) networks, and determine one or more policies managing a traffic distribution of subscriber devices within the plurality of MNO networks. The computing apparatus also includes dynamically switch telecommunications traffic by sending instructions to the subscriber device to modify a prioritized list of the plurality of MNO networks in accordance with the one or more policies.

In one aspect, a non-transitory computer-readable storage medium includes instructions that, when executed by a computer, cause the computer to receive analytics at a customer application function from a mobile virtual network operator (MVNO) application function, the analytics based on monitoring a dynamic traffic status of one or more nodes servicing a subscriber device, receive negotiated service rate plans from a plurality of mobile network operator (MNO) networks, and determine one or more policies managing a traffic distribution of subscriber devices within the plurality of MNO networks. The non-transitory computer-readable storage medium also includes dynamically switch telecommunications traffic by sending instructions to the subscriber device to modify a prioritized list of the plurality of MNO networks in accordance with the one or more policies.

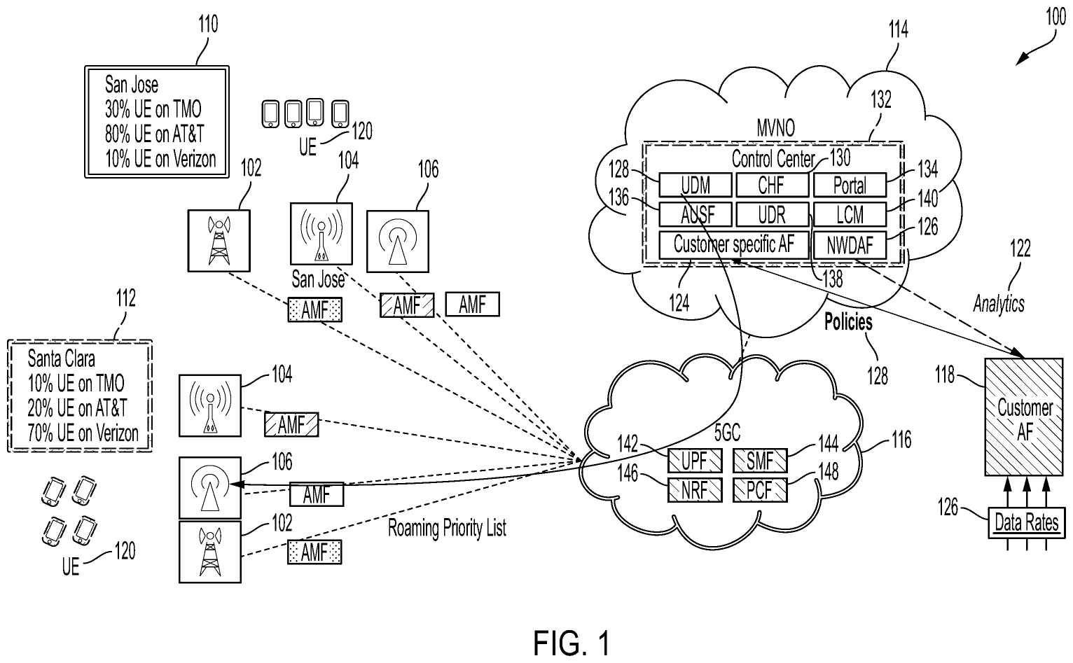

FIG. 1 illustrates an example 5G as a Service (5GaaS) computing architecture in accordance with an example embodiment. System 100 includes various mobile network operators (MNOs), such as MNO 102, MNO 104, and MNO 106 operating in multiple geographic locations, such as San Jose 110 and Santa Clara 112. Any number of MNOs and any number of locations the MNOs cover are contemplated by the techniques described herein. MNO 102, MNO 104, and MNO 106 in locations San Jose 110 and Santa Clara 112 are in connection with mobile virtual network operator (MVNO) 114 and a 5G Core Network (5GC) 116. A customer Application Function (AF) 118 is in connection with MVNO 114.

In the example embodiment, a 5G as a Service (5GaaS) has been deployed and 5GC 116 is partnering with MNO 102, MNO 104, and MNO 106 for implementing a Radio Access Network (RAN) for a customer's user equipment (UEs) 120. The customer, through the Customer AF 118, has taken a number (e.g., 100K) of subscriber identity modules (SIMs) from MVNO 114 and is using it in the locations Santa Clara 112 and San Jose 110 where MNO 102, MNO 104, and MNO 106 all have RAN deployment. The customer has negotiated rate plans for all three of the RAN vendors and, based on the rate plans being below a specific cost level, satisfying connection requirements, Quality of Service (QoS) requirements, etc., wants their UEs to connect to RAN at certain traffic percentage levels. For example, based on the rate plans, Customer AF 118 may connect to RAN in the following way: In San Jose 110—30% UE on MNO 106, 80% UE on MNO 104, and 10% UE on MNO 102. In Santa Clara 112—10% UE on MNO 106, 20% UE on MNO 104, and 70% UE on MNO 102.

MVNO 114 can in some embodiments act like a subscriber cloud network, which may buy service from multiple service providers such as MNO 102, MNO 104, and MNO 106. MVNO 114 may negotiate some rate transmit service for MNO 102, MNO 104, and MNO 106. And then the UE's 120—devices used by the user/employees of the subscriber—may start using the service at the rates negotiated by MVNO 114. Therefore, MVNO 114 is getting some rate 1 from MNO 102 for sessions, some rate 2 from MNO 104 for sessions, and some rate 3 from MNO 106.

At some point in time, it's discovered that MNO 106 offers a better rate than MNO 102 and MNO 104, so it would be advantageous to switch most subscribers to MNO 106. On another day, MNO 104 may offer better rates, so it would be preferable to switch the subscriber devices to MNO 104.

System 100 provides a service in which UEs for a customer can be dynamically switched from one radio service provider to another radio service provider, or from one MNO to another MNO. In order to do so, the customer AF 118 can receive analytics 122 from a customer specific application function (MVNO AF 124), on MVNO 114. The analytics 122 can based, for example, on the MVNO 114 monitoring a dynamic traffic status of one or more nodes servicing a subscriber UE 120 device, including nodes at a subset or all the different locations (e.g., San Jose 110 and/or Santa Clara 112). The Customer AF 118 can receive negotiated service rate plans (e.g., Data Rates 126) from the MNO networks MNO 102, MNO 104, and MNO 106, and determine one or more policies 128 managing a traffic distribution of UEs 120 within the group of MNO networks. The Customer AF 118 can send the policies 128 to MVNO 114. Then MVNO 114 can, based on the policies 128, dynamically switch telecommunications traffic between MNO 102, MNO 104, and MNO 106 by sending instructions to each UE 120 to modify a prioritized list of the MNO networks (MNO 102, MNO 104, and MNO 106) in accordance with the one or more policies 128.

For example, for any given day, the supply and demand of network use fluctuates for a given MNO. As an example, in the San Jose 110 area during the middle of the day (e.g., 2-4 pm, and time of the month, a time of year, holidays, etc.), network utilization can be at 50% for MNO 102. This means more subscribers (UEs 120) can be supported by the service provider MNO 102. This allows MNO 102 to lower their rates during that time. This triggers MVNO 114 to dynamically move UEs 120 over to MNO 102.

In some embodiments, this process works through a couple of application functions (AFs): one AF is within MVNO 114 (e.g., MVNO AF 124), and the other is owned by the customer (e.g., Customer AF 118). MVNO 114 provides analytics 122 to the Customer AF 118. The analytics 122 can, for example, analyze KPI's such as: number of PDU sessions on a given slice, volume of traffic, volume of certain session type, and or status KPI's, which provided in portion or entirely to the Customer AF 118.

MVNO 114 can include, for example, a control center 132 that includes a network data analytics function (NWDAF) 126 that gets status updates from the various nodes within the core network 5GC 116. The NWDAF 126 provides these status updates to the Customer AF 118, and the Customer AF 118 can communicate with the service providers to get rate information (Data Rates 126). MVNO 114 can further include a Unified data Management (UDM) 128 that is responsible for primarily storing the subscriber data, such as UE 120 data related to the customer. Additionally and/or alternatively, MVNO 114 can include a Charging Function (CHF) 130 that supports the online charging, offline charging, and convergent charging models which can enable a 5G business-like slice charging scenarios. Portal 134 can act as a cloud portal, and Authentication Server Function (AUSF) can provide UE 120 authentication services. User Data Repository (UDR) 138 receives subscriber-related policies 128 for UE 120 attach and session establishment, and Local Congestion Mitigation (LCM) 140 provides service providers with a toolset for congestion mitigation.

5GC 116 can include a User Plane Function (UPF) 142 that is responsible for packet routing and forwarding, packet inspection, QoS handling, and external PDU sessions for interconnecting data. Additionally and/or alternatively, 5GC 116 can include a Session Management Function (SMF) 144 for session management with supported individual functions on a per-session basis. The Network Repository Function (NRF) 146 functions as a centralized repository for all the 5G network functions, and the Policy Control Function (PCF) 148 supports 5G QoS policy and charging control functions and the related 5G signaling interfaces, provides policy rules for control plane functions, which include network slicing, roaming, and mobility management, collects subscriber metrics in context with their network, usage, applications, and more (The operators analyze this information to optimize resources and make informed decisions to segment users), and provides real-time management of subscribers, applications, and network resources based on the business rules configured for a service provider.

Based on the analytics 122 provided to the Customer AF 118 from NWDAF 126 on MVNO 114, a decision will be made at Customer AF 118 whether to move one or more UEs 120 from one MNO to another MNO. For example, Customer AF 118 can decide to, at a specific time or time period, move 20% of MNO 106 traffic to MNO 104 because MNO 104 is cheaper at that specific time or time period. This decision can be based on data rates 126 and/or analytics 122, either individually or as a weighted combination.

That decision will be communicated through policies 128. Policies 128 can therefore move 20% of MNO 106 traffic to MNO 104 in certain locations (e.g., San Jose 110). Based on the generation of policies 128, the Customer AF 118 triggers the movement of the traffic by providing the policies 128 to the MVNO AF 124 on MVNO 114.

MVNO 114 switches traffic between the MNOs based on Steering of Roaming (SoR) functionalities. For example, a message can go through UDM 128 to the UE 120. A prioritized list of operators is given to the UE 120. This means that if initially the UE 120 is currently latched onto the MNO 106 network, and then UE 120 sees that a new SoR has come which lists MNO 104 as top priority and MNO 106 is not a priority (lower or even off the prioritized list), the UE 120 will automatically switch from MNO 106 to MNO 104. This can be done for all or a portion of UE 120 devices associated with the customer, and can be done for all or a portion of UE 120 devices currently located in one or more locations.

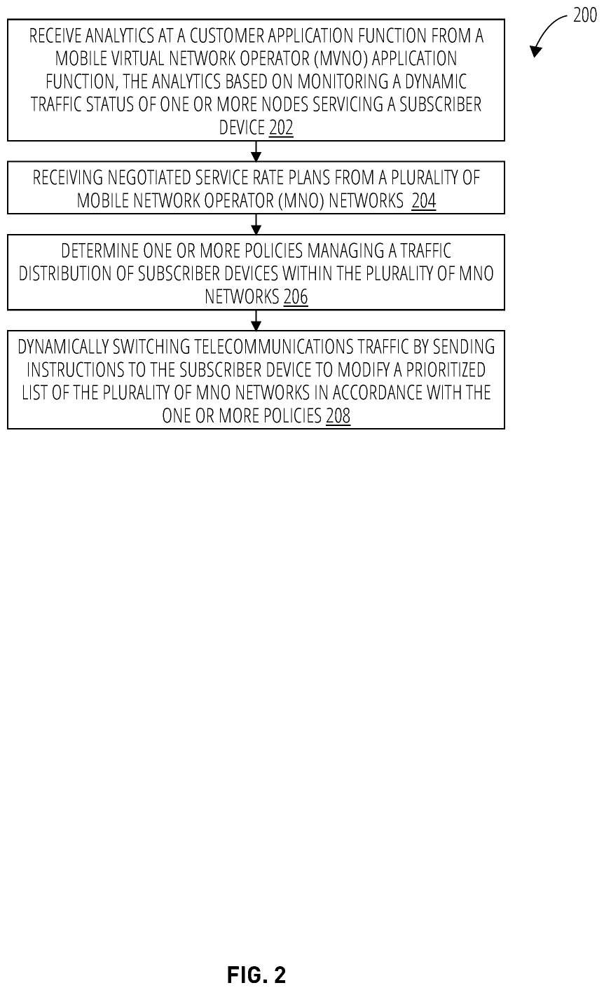

FIG. 2 illustrates a flowchart for dynamically controlling the distribution of user equipment (UEs) over different Radio Access Network (RAN) partners in accordance with an example embodiment.

In block 202, routine 200 receives analytics at a customer application function from a mobile virtual network operator (MVNO) customer-specific application function (MVNO AF), the analytics based on monitoring a dynamic traffic status of one or more nodes servicing a subscriber device. The analytics can, for example, provide to the customer AF, for each MNO network, analyzed KPI's such as: number of PDU sessions on a given slice, volume of traffic, volume of certain session type, and or status KPI's, which are provided to the Customer AF. In some embodiments, additionally and/or alternatively the analytics can provide information of one or more of a volume of traffic specific to Data Network Name (DNN) slices to divide a physical network infrastructure associated with each MNO network into multiple virtual networks, each with its own resources and quality of service (QoS) requirements.

In block 204, routine 200 receives negotiated service rate plans from a plurality of MNO networks. In block 206, routine 200 determines one or more policies managing a traffic distribution of subscriber devices within the plurality of MNO networks. And in block 208, routine 200 can dynamically switch telecommunications traffic by sending instructions to the subscriber device to modify a prioritized list of the plurality of MNO networks in accordance with the one or more policies.

For example, telecommunications traffic can be switched by the MVNO sending instructions to the subscriber device (e.g., a UE) to modify a prioritized list of the plurality of MNO networks in accordance with the one or more policies. In some embodiments, the one or more policies include an operator specific policy of a second MNO network that is applied to the subscriber device when the subscriber device is dynamically moved from a first MNO network to the second MNO network. In some embodiments, the one or more policies are based on running a cost analysis for its subscriber devices across each MNO network. In some embodiments, the one or more policies managing the traffic distribution move connections from the subscriber device from a first MNO network to a second MNO network based on a DNN slice of the subscriber device. In some embodiments, the one or more policies managing the traffic distribution move connections from the subscriber device from a first MNO network to a second MNO network based on a 5G globally unique Subscription Permanent Identifier (SUPI) range of the subscriber device.

In some embodiments, telecommunications traffic can be switched by the MVNO based on subscriber device/UE location. For example, the Customer AF can determine to move a subset of the subscriber devices within a location from a first MNO network to a second MNO network based on receiving the analytics and the negotiated service rate plans. After identifying all subscriber devices that are within a subset of the subscriber devices that belong to the location, the MVNO can send a steering of roaming (SoR) request to all the subscriber devices to modify the prioritized list of the plurality of MNO networks to prioritize the first MNO network over the second MNO network.

In some embodiments, telecommunications traffic can be switched by determining a roaming partner's list (RPL) for the subscriber device based on a current load of the one or more nodes and a configured load. The SoR request for the subscriber device can be modified, and the SoR request can then be sent to a UDM service to trigger SoR towards the subscriber device.

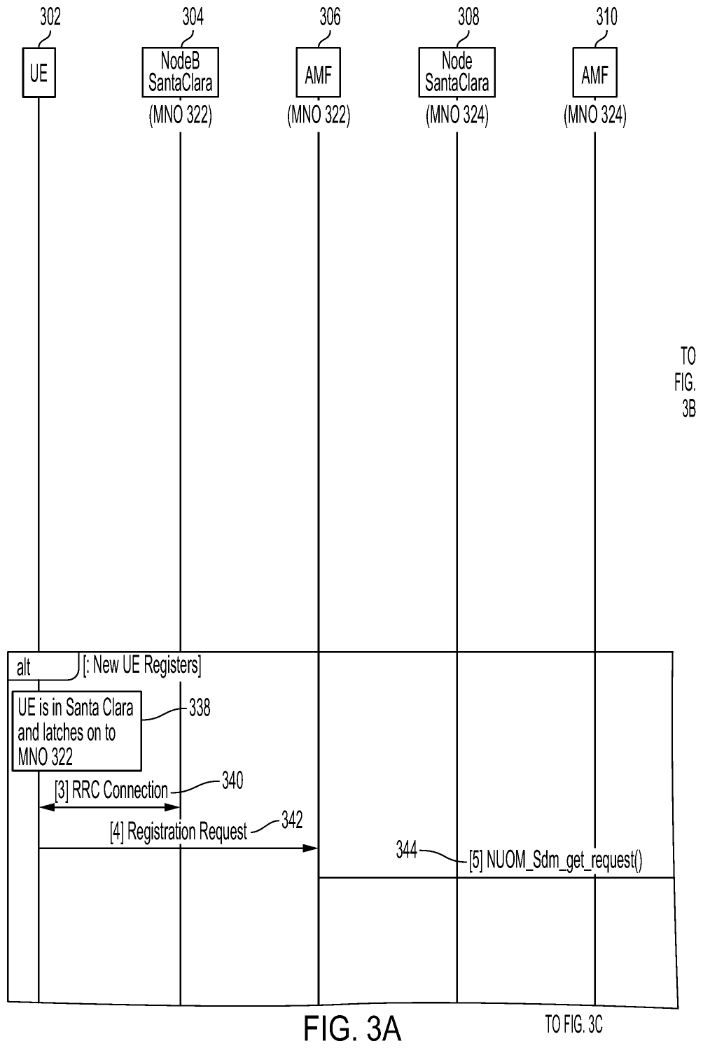

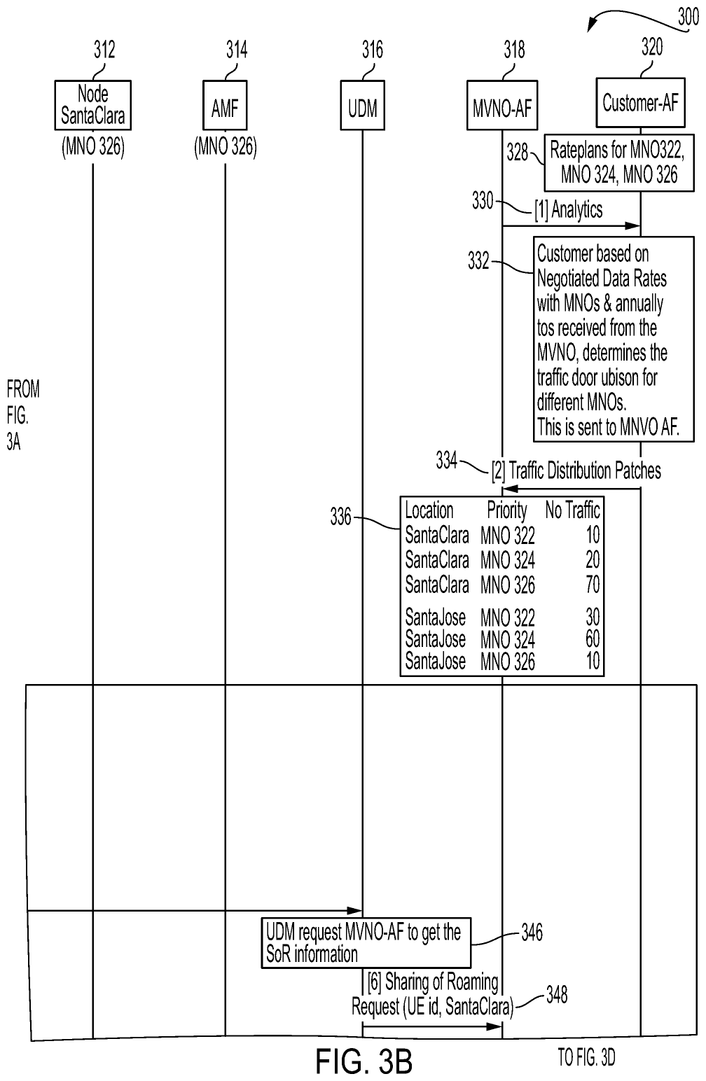

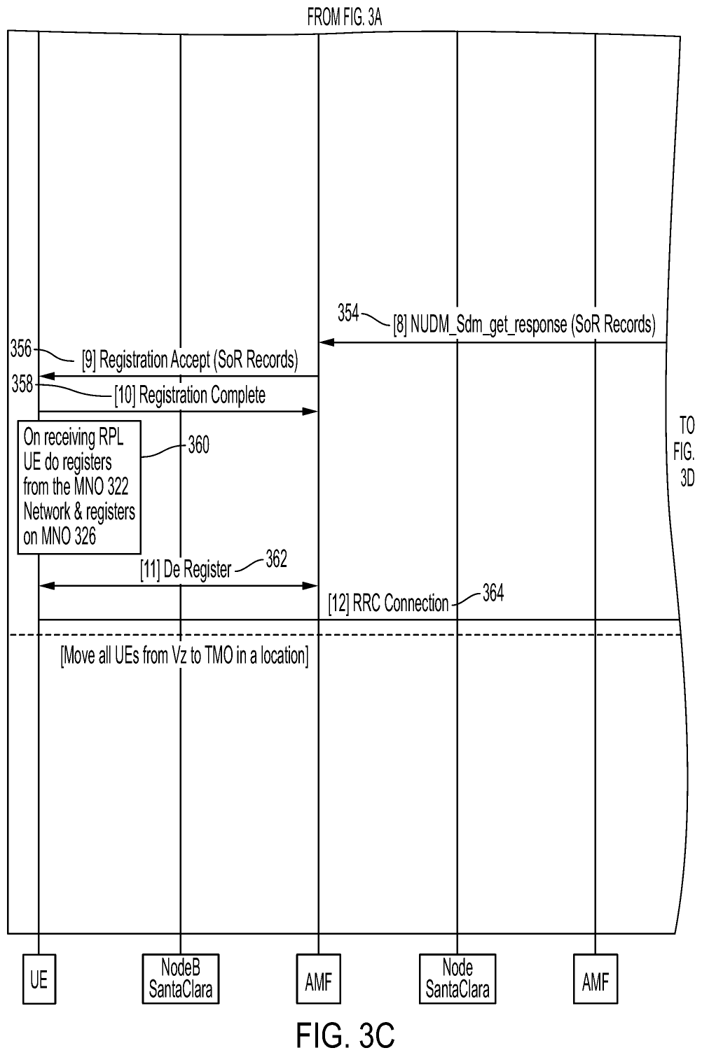

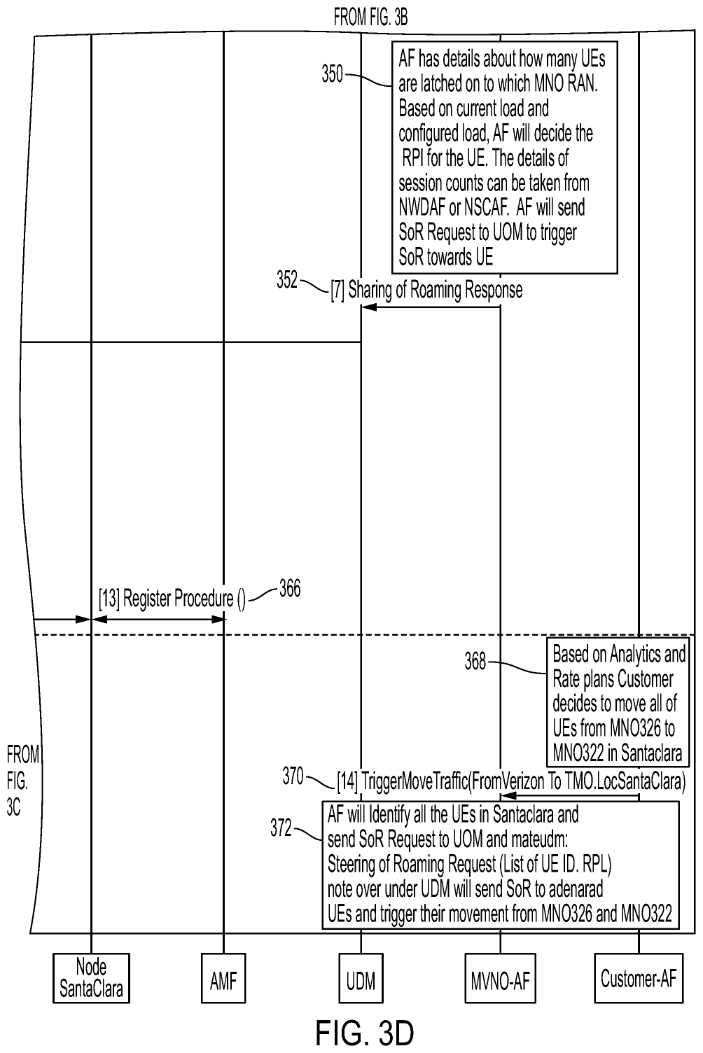

FIG. 3A-3D illustrates an example communication diagram for implementing a dynamically controlled distribution of UEs over multiple RAN partners in accordance with an example embodiment. System 300 includes UE 302, Node 304 associated with MNO 322 at the Santa Clara location, Access and Mobility Management Function (AMF) 306 associated with MNO 322, Node 308 associated with MNO 324 at the Santa Clara location, AMF 310 associated with MNO 324, Node 312 associated with MNO 326 at the Santa Clara location, AMF 314 associated with MNO 326, UDM 316, MVNO-AF 318, and Customer AF 320. System 300 is based on moving sessions from one mobile network operator (MNO 322) to another MNO (MNO 324 and/or MNO 326) by triggering Steering of Roaming (SoR) from the mobile virtual network operators (MVNO) based on policies received from the customer application function (AF) (Customer AF 320). MVNO-AF 318 will use these policies to determine the UEs 302 whose sessions have to be moved and send SoR with an updated RPL (roaming partner's list). Additionally, MVNO will provide usage analytics to the customer AF 320 so that it can use these analytics in generating traffic movement policies.

In some embodiments, the Customer AF 320 receives 328 rate plans from MNO 322, MNO 324, and MNO 326. The MVNO AF 318 sends 330 to the Customer AF 320 analytics. In some embodiments, the MVNO AF 318 can deliver analytics to Customer AF 320 via NEF or directly.

Based on the received analytics and negotiated data rates with each of MNO 322, MNO 324, and MNO 326, the Customer AF 320 determines 332 determined the traffic distribution for the MNO (e.g., traffic distribution to each of MNO 322, MNO 324, and MNO 326). For example, the Customer AF 320 gets the analytics feedback from the MVNO AF 318 about current traffic. Some of the analytics that MVNO AF 318 provides to the Customer AF 320 for each MNO are, but are not limited to, the number of Registrations, number of PDU Sessions, volume of traffic specific to DNN/Slices. In some embodiments, the Customer AF 320 also gets the rate plans 328 from different MNOs dynamically or thru a provisioning portal. In any case, the Customer AF 320 will run various models related to cost analysis and come up with a new traffic distribution policy for its UEs across different MNOs. Various kinds of policies can be, but are not limited to, moving connections from UEs at a given location (or multiple locations) from one MNO to other MNO based on a percentage of UEs (e.g., move 20% of UEs); SUPI/PEI range (e.g., UEs with SUPI values from 1000-2000 should be moved; UEs within SIM card and IMEI ranges in 4G networks should be moved; UEs within SUPI and PEI ranges in 5G networks should be moved, etc.); IDLE/Active status of UE; and/or policies specific to a DNN/Slice.

The MVNO AF 318 can receive 334 traffic distribution policies from the Customer AF 320. Based on the traffic policies, the MVNO AF 318 can determine the traffic that needs to be moved from one MNO to other MNO. It can identify specific UEs which need to be moved from one MNO to other MNO based on policies received from Customer AF 320. For example, MVNO AF 318 can provision traffic in accordance with the policies like the following priority list 336: For the Santa Clara location, 10% of UEs to MNO 322, 10% of UEs to MNO 324, and 70% of UEs to MNO 326 based on the listed priorities. For the San Jose location, 30% of UEs to MNO 322, 60% of UEs to MNO 324, and 10% of UEs to MNO 326 based on the listed priorities. How the traffic is distributed based on the priority list can depend on a couple of scenarios, such as if the UE 302 is newly registering/connecting to the network, or is already on the network and is being moved with other similar UEs.

For a UE that is newly registering, in some embodiments, the UE latches 338 onto an MNO at a specific location. In the example embodiment shown, UE 302 is in Santa Clara and latches onto MNO 322. Next comes the registration process, where UE 302 and node 304 establish an Remote Procedure Call (RPC) connection 340, and then UE 302 sends a registration request 342 to AMF 306. The AMF 306 sends a Nudm_UEAuthentication service (NUDM) get request 344 to UDM 316 to select an authentication method, where UDM 316 requests 346 MVNO—AF 318 to get the Steering of Roaming (SoR) information. UDM 316 then sends an SoR request 348 to MVNO AF 318, including a UE ID and/or location information (e.g., Santa Clara).

The MVNO AF 318 then initiates 350 UE movement from one MNO to another MNO. The MVNO AF 318 has details about how many UEs are latched on to which MNO RAN. Based on the current load and the configured load, the MVNO AF 318 will decide the roaming partner's list (RPL) for the UE 302. In some embodiments, the details of session counts can be taken from the network data analytics function (NWDAF) or the Network Slice Access Control Function (NSCAF). The MVNO AF 318 will send an SoR request to UDM 316 to trigger SoR towards UE 302.

For example, MVNO AF 318 can send a SoR Response 352 to UDM 316 with traffic preferences related to MNO 322, MNO 324, and MNO 326. For UE 302, UDM 316 sends to AMF 306 an NUDM get response 354, which triggers AMF 306 to send to UE 302 a registration accept 356. UE 302 sends a registration complete message 358 to AMF 306. Upon receiving the RPL, the UE 302 de-registers 360 from the MNO 322 network and registers on the MNO 326 network. For example, UE 302 sends a de-register message 362 to AMF 306, and then sends an RPC Connection 364 to node 312 and initiates a register procedure 366 with AMF 314.

For a UE that has been on the network and/or previously registered, in some embodiments, the Customer AF 320 decides 368 to move all or a portion of UE's within a location from one MNO to another based on the analytics received from MVNO AF 318 and the rate plans received from the MNOs. For example, in this example embodiment, the Customer AF 320 can decide to move all the UEs from MNO 326 to MNO 322 in Santa Clara. To do so, the Customer AF 320 sends a trigger 370 to move traffic from MNO 326 to MNO 322 and a location tag (e.g., Loc: Santa Clara). The MVNO AF 318 will then identify 372 all the UEs in Santa Clara and send an SoR request to UDM 316. UDM 316 will then send the SoR to the identified UEs, including UE 302 and trigger their movement from MNO 326 to MNO 322.

In some embodiments, the MVNO AF 318 will get the GUTI of the UEs which are registered in a given location for specific slices/DNNs from the AMFs (e.g., AMF 306, AMF 310, and AMF 314) and/or UDM 316. It will determine the percentage of UEs that need to be moved. For example, the MVNO AF 318 can use policies based on e.g.: move IDLE UEs first or based on priority of the traffic or DNN/Slice. The MVNO AF 318 can construct the RPL (roaming priority list) for the identified UEs and then indicate UDM 316 to trigger SoR towards UEs (such as UE 302).

In some embodiments, when UE 302 is moved from MNO 322 to MNO 324 and/or MNO 326, new policies are applied. For example, one or more MNO-specific policies can be associated on UE 302 after UE 302 gets moved between the two networks. In some embodiments, this can be done in the scope of the control center/MVNO AF 318.

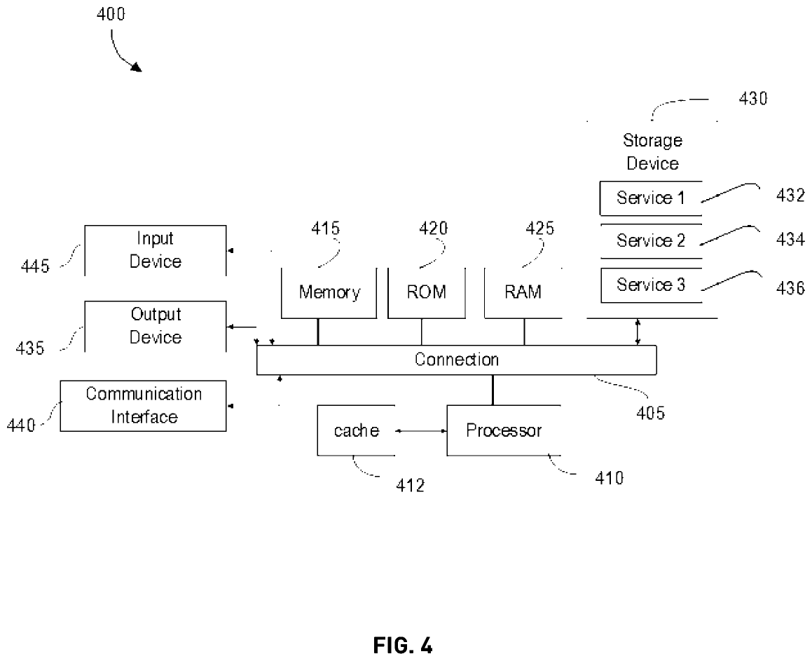

FIG. 4 shows an example of computing system 400, which can be for example any computing device or any component thereof in which the components of the system are in communication with each other using connection 405. Connection 405 can be a physical connection via a bus, or a direct connection into processor 410, such as in a chipset architecture. Connection 405 can also be a virtual connection, networked connection, or logical connection.

In some embodiments computing system 400 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 400 includes at least one processing unit (CPU or processor) 410 and connection 405 that couples various system components including system memory 415, such as read only memory (ROM) 420 and random access memory (RAM) 425 to processor 410. Computing system 400 can include a cache of high-speed memory 412 connected directly with, in close proximity to, or integrated as part of processor 410.

Processor 410 can include any general purpose processor and a hardware service or software service, such as services 432, 434, and 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction, computing system 400 includes an input device 445, which can represent any number of input mechanisms, such as a microphone for speech, a touch-sensitive screen for gesture or graphical input, keyboard, mouse, motion input, speech, etc. Computing system 400 can also include output device 435, which can be one or more of a number of output mechanisms known to those of skill in the art. In some instances, multimodal systems can enable a user to provide multiple types of input/output to communicate with computing system 400. Computing system 400 can include communications interface 440. which can generally govern and manage the user input and system output. There is no restriction on operating on any particular hardware arrangement and therefore the basic features here may easily be substituted for improved hardware or firmware arrangements as they are developed.

Storage device 430 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 430 can include software services, servers, services, etc., that when the code that defines such software is executed by the processor 410, it causes the system to perform a function. In some embodiments, a hardware service that performs a particular function can include the software component stored in a computer-readable medium in connection with the necessary hardware components, such as processor 410, connection 405, output device 435, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be soft ware that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method comprising:
receiving analytics at a customer application function from a mobile virtual network operator (MVNO) application function, the analytics based on monitoring a dynamic traffic status of one or more nodes servicing a subscriber device;
receiving negotiated service rate plans from a plurality of mobile network operator (MNO) networks; and
determining one or more policies managing a traffic distribution of subscriber devices within the plurality of MNO networks; and
dynamically switching telecommunications traffic by sending instructions to the subscriber device to modify a prioritized list of the plurality of MNO networks in accordance with the one or more policies.

2. The method of claim 1, the method further comprising:
determining to move a subset of the subscriber devices within a location from a first MNO network to a second MNO network based on receiving the analytics and the negotiated service rate plans;
identifying subscriber devices within the subset of the subscriber devices that belong to the location; and
sending a steering of roaming (SoR) request to all the subscriber devices to modify the prioritized list of the plurality of MNO networks to prioritize the first MNO network over the second MNO network.

3. The method of claim 1, the method further comprising:
determining a roaming partner's list (RPL) for the subscriber device based on a current load of the one or more nodes and a configured load;
modifying a steering of roaming (SoR) request for the subscriber device; and
sending the SoR request to a Unified Data Management (UDM) service to trigger SoR towards the subscriber device.

4. The method of claim 1, wherein the one or more policies include an operator specific policy of a second MNO network that is applied to the subscriber device when the subscriber device is dynamically moved from a first MNO network to the second MNO network.

5. The method of claim 1, wherein the analytics provides to the customer application function, for each MNO network, one or more of a volume of traffic specific to Data Network Name (DNN) slices to divide a physical network infrastructure associated with each MNO network into multiple virtual networks, each with its own resources and quality of service (QoS) requirements.

6. The method of claim 1, wherein the one or more policies is based on running a cost analysis for its subscriber devices across each MNO network.

7. The method of claim 6, wherein the one or more policies managing the traffic distribution move connections from the subscriber device from a first MNO network to a second MNO network based on a DNN slice of the subscriber device.

8. The method of claim 6, wherein the one or more policies managing the traffic distribution move connections from the subscriber device from a first MNO network to a second MNO network based on a 5G globally unique Subscription Permanent Identifier (SUPI) range of the subscriber device.

9. A computing apparatus comprising:
a processor; and
a memory storing instructions that, when executed by the processor, configure the apparatus to:
receive analytics at a customer application function from a mobile virtual network operator (MVNO) application function, the analytics based on monitoring a dynamic traffic status of one or more nodes servicing a subscriber device;
receive negotiated service rate plans from a plurality of mobile network operator (MNO) networks; and
determine one or more policies managing a traffic distribution of subscriber devices within the plurality of MNO networks; and
dynamically switch telecommunications traffic by sending instructions to the subscriber device to modify a prioritized list of the plurality of MNO networks in accordance with the one or more policies.

10. The computing apparatus of claim 9, wherein the instructions further configure the apparatus to:
determine to move a subset of the subscriber devices within a location from a first MNO network to a second MNO network based on receiving the analytics and the negotiated service rate plans;
identify subscriber devices within the subset of the subscriber devices that belong to the location; and
send a steering of roaming (SoR) request to all the subscriber devices to modify the prioritized list of the plurality of MNO networks to prioritize the first MNO network over the second MNO network.

11. The computing apparatus of claim 9, wherein the instructions further configure the apparatus to:
determine a roaming partner's list (RPL) for the subscriber device based on a current load of the one or more nodes and a configured load;
modify a steering of roaming (SoR) request for the subscriber device; and
send the SoR request to a Unified Data Management (UDM) service to trigger SoR towards the subscriber device.

12. The computing apparatus of claim 9, wherein the one or more policies include an operator specific policy of a second MNO network that is applied to the subscriber device when the subscriber device is dynamically moved from a first MNO network to the second MNO network.

13. The computing apparatus of claim 9, wherein the analytics provides to the customer application function, for each MNO network, one or more of a volume of traffic specific to Data Network Name (DNN) slices to divide a physical network infrastructure associated with each MNO network into multiple virtual networks, each with its own resources and quality of service (QoS) requirements.

14. The computing apparatus of claim 9, wherein the one or more policies is based on running a cost analysis for its subscriber devices across each MNO network.

15. The computing apparatus of claim 14, wherein the one or more policies manage the traffic distribution move connections from the subscriber device from a first MNO network to a second MNO network based on a DNN slice of the subscriber device.

16. The computing apparatus of claim 14, wherein the one or more policies manage the traffic distribution move connections from the subscriber device from a first MNO network to a second MNO network based on a 5G globally unique Subscription Permanent Identifier (SUPI) range of the subscriber device.

17. A non-transitory computer-readable storage medium, the computer-readable storage medium including instructions that when executed by a computer, cause the computer to:
receive analytics at a customer application function from a mobile virtual network operator (MVNO) application function, the analytics based on monitoring a dynamic traffic status of one or more nodes servicing a subscriber device;
receive negotiated service rate plans from a plurality of mobile network operator (MNO) networks; and
determine one or more policies managing a traffic distribution of subscriber devices within the plurality of MNO networks; and
dynamically switch telecommunications traffic by sending instructions to the subscriber device to modify a prioritized list of the plurality of MNO networks in accordance with the one or more policies.

18. The non-transitory computer-readable storage medium of claim 17, wherein the instructions further configure the computer to:
determine to move a subset of the subscriber devices within a location from a first MNO network to a second MNO network based on receiving the analytics and the negotiated service rate plans;
identify subscriber devices within the subset of the subscriber devices that belong to the location; and
send a steering of roaming (SoR) request to all the subscriber devices to modify the prioritized list of the plurality of MNO networks to prioritize the first MNO network over the second MNO network.

19. The non-transitory computer-readable storage medium of claim 17, wherein the instructions further configure the computer to:
determine a roaming partner's list (RPL) for the subscriber device based on a current load of the one or more nodes and a configured load;
modify a steering of roaming (SoR) request for the subscriber device; and
send the SoR request to a Unified Data Management (UDM) service to trigger SoR towards the subscriber device.

20. The non-transitory computer-readable storage medium of claim 17, wherein the one or more policies include an operator specific policy of a second MNO network that is applied to the subscriber device when the subscriber device is dynamically moved from a first MNO network to the second MNO network.
